(19) United States
(12) Patent Application Publication
(10) Pub. No.: US 2006/0253674 A1
(43) Pub. Date: Nov. 9, 2006

(54) Automatic disk healing

(75) Inventors: Ofir Zohar, Alfe-Menashe (IL); Yaron Revah, Tel-Aviv (IL); Haim Helman, Ramat Gan (IL); Dror Cohen, Tel Aviv (IL); Shemer Schwartz, Herzelia (IL)

Correspondence Address: KATTEN MUCHIN ROSENMAN LLP, 575 MADISON AVENUE, NEW YORK, NY, 10022-2585, US

(73) Assignee: XIV LTD.

(21) Appl. No.: 11/123,634

(22) Filed: May 6, 2005

(51) Int. Cl. G06F 13/00

(52) U.S. Cl. 711/165; 711/154

(57) ABSTRACT

A method for operating a data storage system that responds to IO data requests from one or more hosts, the system including a first and one or more second mass storage devices, each of the devices having respective data stored therein. The method includes defining an unacceptable level of activity, and performing the following steps automatically, without intervention by a human operator. Detecting the unacceptable level of activity on the first mass storage device; in response to detecting the unacceptable level of activity, transferring the data stored in the first mass storage device to the second mass storage devices, while responding to the IO data requests; reformatting the first mass storage device; and, after reformatting the first mass storage device, transferring the data stored in the second mass storage devices to the first mass storage device, while responding to the IO data requests.

### FIELD OF THE INVENTION

The present invention relates generally to data storage systems, and specifically to actions taken when an element of the system becomes faulty.

### BACKGROUND OF THE INVENTION

A data storage system typically includes mechanisms for dealing with failure or incorrect operation of an element of the system, so that the system may recover “gracefully” from the failure or incorrect operation. One such mechanism is the incorporation of redundancy into the system, wherein one or more alternative elements are available to take over from an element that is found to be faulty. Other mechanisms are also known in the art.

U.S. Pat. No. 5,666,512 to Nelson, et al., whose disclosure is incorporated herein by reference, describes a data storage system comprising a number of disks which are managed by a memory manager. The memory manager maintains a sufficient quantity of hot spare storage space for reconstructing user data and restoring redundancy in the event that one of the storage disks fails.

U.S. Pat. No. 6,418,068 to Raynham, whose disclosure is incorporated herein by reference, describes a self-healing memory comprising primary memory cells and a spare memory cell. A detector is able to detect an error in one of the primary memory cells. When an error occurs, a controller maps the memory cell having the error to the spare memory cell.

U.S. Pat. No. 6,449,731 to Frey, Jr., whose disclosure is incorporated herein by reference, describes a method to manage storage of an object in a computer system having more than one management storage process. A memory access request is routed to a first storage management process, which is determined to have failed. The request is then routed to a second storage management process, which implements the request.

U.S. Pat. No. 6,530,036 to Frey, Jr., whose disclosure is incorporated herein by reference, describes a self-healing storage system that uses a proxy storage management process to service memory access requests when a storage management process has failed. The proxy accesses relevant parts of a stored object to service the memory access requests, updating the stored object's information to reflect any changes.

U.S. Pat. No. 6,604,171 to Sade, whose disclosure is incorporated herein by reference, describes managing a cache memory by using a first cache memory, copying data from the first cache memory to a second cache memory, and, following copying, using the second cache memory along with the first cache memory.

U.S. Patent Application 2005/0015554 to Zohar, et al., whose disclosure is incorporated herein by reference, refers to a data storage system having a number of caches. The disclosure describes detecting an inability of one of the caches of the system to retrieve data from or store data at a range of logical addresses. In response to the inability, one or more other caches are reconfigured to retrieve data from and store at the range while continuing to retrieve data from and store at other ranges of logical addresses.

In addition to the mechanisms described above, methods are known in the art that predict, or attempt to predict, occurrence of failure or incorrect operation in an element of a storage system. One such method, known as Self-Monitoring Analysis and Reporting Technology (SMART) incorporates logic and/or sensors into a hard disk drive to monitor characteristics of the drive. A description of SMART, incorporated herein by reference, is found at www.pcguide.com/ref/hdd/perf/qual/featuresSMART-c.html. Values of the monitored characteristics are used to predict a possible pending problem, and/or provide an alert for such a problem.

### SUMMARY OF THE INVENTION

In embodiments of the present invention, a data storage system comprises a plurality of mass storage devices which store respective data therein, the data being accessed by one or more hosts. An unacceptable level of activity is defined for the devices, the unacceptable level being defined in terms of a operating characteristics of elements of the system. During operation of the system, the unacceptable level may be detected on one of the mass storage devices of the system, herein termed the suspect device. In this case, while the system continues to respond to data requests from the one or more hosts, the data on the suspect device is automatically transferred to one or more other mass storage devices in the system. When the transfer is complete, the suspect device is automatically reformatted, and/or powered down then up, and the data that was transferred from the device is then transferred back to it, from the other mass storage devices.

Configuring the data storage system to automatically reformat a storage device, and/or to switch power from then back to the storage device which then continues its function, while enabling the system to continue operation, provides an extremely useful tool for handling activity problems encountered in the system.

In one embodiment of the present invention, the data stored on the suspect mass storage device has also been stored redundantly on the other mass storage devices. In this case the redundant data may be used for host requests while the transfer of the data from and to the suspect storage device is being performed. In the event that there is more than one mass storage device apart from the suspect device, the transfer of the data from the suspect mass storage device is typically performed so as to maintain the data redundancy.

In some embodiments of the present invention, the data storage system comprises one or more interfaces and/or one or more caches that convey requests for data from the hosts to the mass storage devices. The interfaces and caches comprise routing tables that route the requests to the appropriate devices. During the transfer of the data to and from the suspect mass storage device, the tables are typically updated to reflect the data transfer, so that the data transfer is transparent to the hosts.

There is therefore provided, according to an embodiment of the present invention, a method for operating a data storage system adapted to respond to input/output (IO) data requests from one or more hosts, the system including a first and one or more second mass storage devices, each of the devices having respective data stored therein, the method including:

defining an unacceptable level of activity; and

performing the following steps automatically, without intervention by a human operator:

detecting the unacceptable level of activity on the first mass storage device,

in response to detecting the unacceptable level of activity, transferring the data stored in the first mass storage device to the one or more second mass storage devices, while responding to the 10 data requests,

reformatting the first mass storage device, and

after reformatting the first mass storage device, transferring the data stored in the one or more second mass storage devices to the first mass storage device, while responding to the IO data requests.

Typically, defining the unacceptable level of activity includes receiving one or more parameters related to the IO data requests from the human operator, and the human operator setting the unacceptable level of activity in terms of the one or more parameters.

In one embodiment at least some of the first and the one or more second mass storage devices include volatile mass storage devices and/or non-volatile mass storage devices.

Transferring the data to the one or more second mass storage devices may include copying the data to the one or more second mass storage devices and maintaining a record of locations of the data on the one or more second mass storage devices. Typically, transferring the data stored in the one or more second mass storage devices to the first mass storage device includes using the record to locate the data. The method typically further includes erasing the record and the data copied to the one or more second mass storage devices.

In a disclosed embodiment reformatting the first mass storage device includes checking, after the reformatting, that the device is in a condition to receive the data stored in the one or more mass second mass storage devices.

The method may also include, in response to transferring the data stored in the first mass storage device, updating routing tables for the IO data requests. The method may further include the first and the one or more second mass storage devices storing the respective data with redundancy, wherein updating the routing tables includes updating the tables in response to the redundancy.

In some embodiments the one or more second mass storage devices include two or more second mass storage devices, wherein the first and the two or more second mass storage devices store the respective data with redundancy, and wherein transferring the data stored to the two or more second mass storage devices includes copying the data to the two or more second mass storage devices so as to maintain the redundancy.

There is further provided, according to an embodiment of the present invention, apparatus for operating a data storage system adapted to respond to input/output (IO) data requests from one or more hosts, the system including a first and one or more second mass storage devices, each of the devices having respective data stored therein, the apparatus including:

a system manager which is adapted to:

receive a defined unacceptable level of activity, and perform the following steps automatically, without intervention by a human operator:

detect the unacceptable level of activity on the first mass storage device,

in response to detecting the unacceptable level of activity, transfer the data stored in the first mass storage device to the one or more second mass storage devices, while responding to the IO data requests,

reformat the first mass storage device, and

after reformatting the first mass storage device, transfer the data stored in the one or more second mass storage devices to the first mass storage device, while responding to the IO data requests.

There is further provided, according to an embodiment of the present invention a method for operating a data storage system adapted to respond to input/output (IO) data requests from one or more hosts, the system including a first and one or more second mass storage devices, each of the devices having respective data stored therein, the method including:

defining an unacceptable level of activity; and

performing the following steps automatically, without intervention by a human operator:

detecting the unacceptable level of activity on the first mass storage device,

in response to detecting the unacceptable level of activity, transferring the data stored in the first mass storage device to the one or more second mass storage devices, while responding to the IO data requests,

powering down then powering up the first mass storage device, and

after powering up the first mass storage device, transferring the data stored in the one or more second mass storage devices to the first mass storage device, while responding to the IO data requests.

Transferring the data stored in the one or more second mass storage devices to the first mass storage device may include first reformatting the first mass storage device.

There is further provided, according to an embodiment of the present invention, apparatus for operating a data storage system adapted to respond to input/output (IO) data requests from one or more hosts, the system including a first and one or more second mass storage devices, each of the devices having respective data stored therein, the apparatus including:

a system manager which is adapted to:

receive a defined unacceptable level of activity, and

perform the following steps automatically, without intervention by a human operator:

detect the unacceptable level of activity on the first mass storage device,

in response to detecting the unacceptable level of activity, transfer the data stored in the first mass storage device to the one or more second mass storage devices, while responding to the IO data requests,

power down then power up the first mass storage device, and

after powering up the first mass storage device, transfer the data stored in the one or more second mass storage devices to the first mass storage device, while responding to the IO data requests.

The present invention will be more fully understood from the following detailed description of the embodiments thereof, taken together with the drawings, a brief description of which is given below.

### BRIEF DESCRIPTION OF THE DRAWINGS

FIG. 1 is a schematic block diagram of a data storage system, according to an embodiment of the present invention;

FIG. 2 is a flowchart of a process showing steps taken in the event that the activity of a data storage device in the system of FIG. 1 becomes unacceptable, according to an embodiment of the present invention; and

FIG. 3 is a flowchart of an alternative process showing steps taken in the event that the activity of a data storage device in the system of FIG. 1 becomes unacceptable, according to an embodiment of the present invention.

### DETAILED DESCRIPTION OF EMBODIMENTS

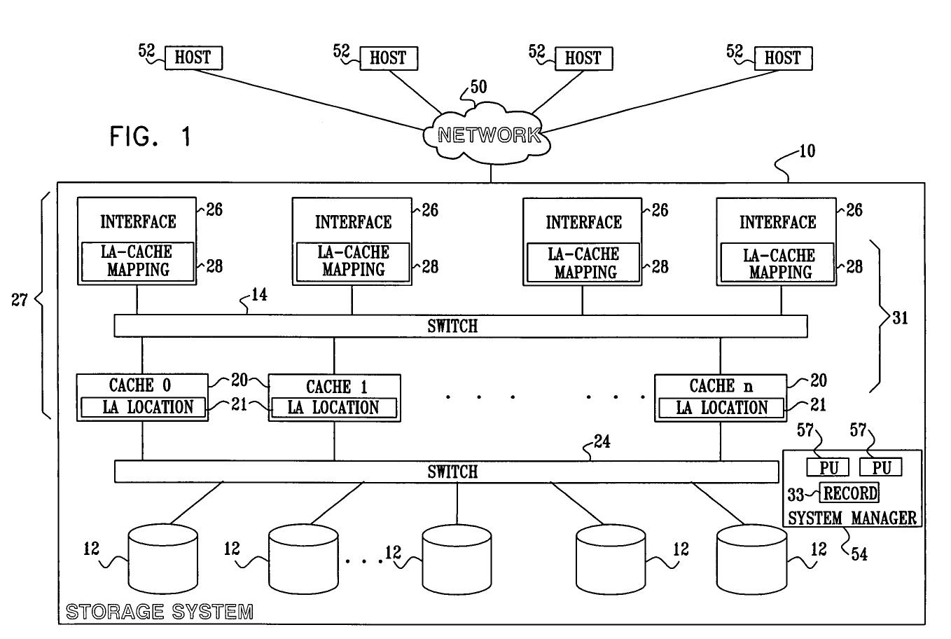

Reference is now made to FIG. 1, which is a schematic block diagram of a storage system 10, according to an embodiment of the present invention. System 10 acts as a data memory for one or more hosts 52, which are coupled to the storage system by any means known in the art, for example, via a network such as the Internet or by a bus. Herein, by way of example, hosts 52 and system 10 are assumed to be coupled by a network 50. The data stored within system 10 is stored at logical addresses (LAs) in one or more slow and/or fast access time non-volatile mass storage devices, hereinbelow assumed to be one or more disks 12, by way of example. LAs for system 10 are typically grouped into logical units (LUs) and both LAs and LUs are allocated by a system manager 54, which also acts as a control unit for the system. System manager 54 is typically implemented as one or more manager processing units 57, which may be incorporated into disks 12, and/or elements of system 10 described hereinbelow. When implemented as multiple units 57, the units typically control system 10 using a distributed algorithm operated in a cooperative manner.

Disks 12 typically incorporate a monitoring technology such as Self-Monitoring Analysis and Reporting Technology (SMART) which is described in the Background of the Invention; if incorporated, system manager 54 may use the technology, as is described below.

System 10 comprises one or more substantially similar interfaces 26 which receive input/output (IO) access requests for data in disks 12 from hosts 52. Each interface 26 may be implemented in hardware and/or software, and may be located in storage system 10 or alternatively in any other suitable location, such as an element of network 50 or one of hosts 52. Between disks 12 and the interfaces are a second plurality of interim caches 20, each cache comprising memory having fast access time, and each cache being at an equal level hierarchically. Each cache 20 typically comprises random access memory (RAM), such as dynamic RAM and/or solid state disks, and may also comprise software. Caches 20 are coupled to interfaces 26 and disks 12 by any suitable fast coupling system known in the art, such as a bus or a switch, so that each interface is able to communicate with, and transfer data to and from, any cache, which is in turn able to transfer data to and from disks 12 as necessary. By way of example, the coupling between caches 20 and interfaces 26 is assumed to be by a first cross-point switch 14, and the coupling between caches 20 and disks 12 is assumed to be by a second cross-point switch 24. Interfaces 26 operate substantially independently of each other. Caches 20 and interfaces 26 operate as a data transfer system 27, transferring data between hosts 52 and disks 12.

At setup of system 10 system manager 54 assigns a range of LAs to each cache 20, so that each cache is able to retrieve data from, and/or store data at, its assigned range of LAs. The ranges are chosen so that the complete memory address space of disks 12 is covered, and so that each LA is mapped to at least one cache; typically more than one is used for redundancy purposes. The assigned ranges for each cache 20 are typically stored in each interface 26 as a substantially similar table, and the table is used by the interfaces in routing IO requests from hosts 52 to the caches. Alternatively or additionally, the assigned ranges for each cache 20 are stored in each interface 26 as a substantially similar function, or by any other suitable method known in the art for generating a correspondence between ranges and caches. Hereinbelow, the correspondence between caches and ranges is referred to as LA range-cache mapping 28, and it will be understood that mapping 28 gives each interface 26 a general overview of the complete cache address space of system 10.

Each cache 20 comprises a respective location table 21 specific to the cache. Each location table gives its cache exact physical location details, on disks 12, for the LA range assigned to the cache. It will be understood that LA range-cache mappings 28 and location tables 21 act as routing tables 31 for data transfer system 27, the routing tables routing a data request from one of hosts 52 to an appropriate disk 12.

In some embodiments of the present invention, data is stored redundantly on disks 12, so that in the event of data on one of disks 12 becoming unavailable, the data has been stored on one or more other disks 12, and so is still available to hosts 52.

A system generally similar to that of system 10 is described in more detail in the above-referenced U.S. Patent Application 2005/0015554. The application describes systems for assigning physical locations on mass storage devices such as disks 12 to caches coupled to the disks; the application also describes methods for redundant storage of data on the mass storage devices.

Typically, manager 54 stores data on disks 12 so that input/output (IO) operations to each disk 12 are approximately balanced. During operation of storage system 10, manager 54 monitors parameters associated with elements of the system, such as numbers of IO operations, elapsed time for an IO operation, average throughput and/or latency during a given period of time, latency of one or more individual transactions, and lengths of task queues at each cache 20 to disks 12, so as to maintain the system in the approximately balanced state. Manager 54 measures the parameters by monitoring activity of interfaces 26, caches 20 and/or disks 12.

As stated above, disks 12 may incorporate a monitoring technology such as SMART, in which case manager 54 typically also uses the technology to monitor characteristics of disks 12. Alternatively or additionally, a human operator of system 10 incorporates software and/or hardware into the system, and/or into disks 12, that enables manager 54 to monitor characteristics of the disks similar to those provided by the monitoring technology.

The human operator of system 10 inputs ranges of values for the parameters and/or the characteristics that, taken together or separately, provide manager 54 with one or more metrics that allow the manager to determine if each of the disks is operating satisfactorily. Using the parameters, characteristics, and/or metrics, the operator defines an unacceptable level of activity of one of the disks.

Such an unacceptable level of activity typically occurs in a specific disk if the disk has a relatively large number of bad sectors, if the data stored on the disk is poorly distributed, if there is an at least partial mechanical or electrical failure in the motor driving the disk or one of the heads accessing the disk, or if a cache accessing the disk develops a fault. The unacceptable level of activity may also be assumed to occur when a monitoring technology such as SMART predicts a future disk failure or problem.

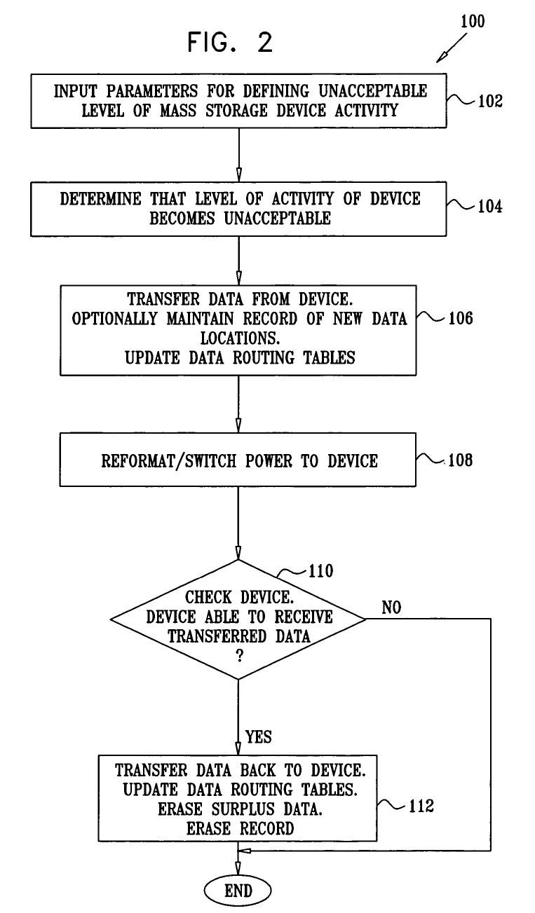

FIG. 2 is a flowchart of a process 100 showing steps taken by manager 54 in the event that the activity of one of disks 12, herein termed the suspect disk, becomes unacceptable, according to an embodiment of the present invention. Process 100 assumes that the data stored on the suspect disk has not also been stored redundantly on any of the other disks 12. In an initial step 102, the operator of system 10 inputs parameters to system 10, as described above, and defines values of the parameters that enable system manager 54 to determine if the level of activity of one of disks 12 becomes unacceptable. The system manager monitors the parameters for all of disks 12.

In a second step 104, manager 54 determines that a level of activity of the suspect disk becomes unacceptable.

In a first data transfer step 106, manager 54 begins copying data from the suspect disk to one or more of the other disks 12. The data is typically copied in batches, and as each batch of data is copied, manager 54 updates mappings 28 and/or location tables 21, as necessary, so that IO requests for copied data are directed to the new locations of the data. Typically, copying of a batch includes confirmation by manager 54 that the copied data in the new location is identical to the original batch on the suspect disk. The process of copying a specific batch, and updating mappings 28 and/or location tables 21 for the batch, is typically implemented by manager 54 as an atomic process and in a way that maintains load balancing. U.S. Patent Application 2005/0015554, referenced above, describes processes that may advantageously be used, mutatis mutandis, in this first data transfer step, and in a second data transfer step described below, to maintain load balancing.

Optionally, manager 54 also maintains a record 33 of the new locations of the data that has been transferred, for use in a second data transfer step 112, described below. Record 33 is typically stored in one of the other disks 12, i.e., not the suspect disk, and/or in a memory within manager 54.

In a step 108, once manager 54 has copied all the data from the suspect disk and updated mappings 28 and/or location tables 21, the manager reformats the suspect disk, thus erasing the data on the suspect disk, typically by using a FORMAT command well known in the art. In an embodiment of the present invention, the reformatting is performed by actively writing, typically with all zeros, on the suspect disk so that all original data is overwritten. Alternatively or additionally, the reformatting is performed by erasing a file allocation table on the suspect disk.

In a further alternative embodiment of the present invention, in step 108 manager 54 may power down the suspect disk, and then switch the disk back to full operational power. Manager 54 may implement the power change as well as, or in place of, reformatting the disk, in order to attempt to return the disk to an acceptable level of operation. The inventors have found that automatically powering down, then powering up the disk, may be sufficient to enable the disk to return to an acceptable level of operation. The period during which the disk is powered down is typically of the order of seconds, and may be input by the operator as one of the parameters in step 102. Typically, the period is sufficient for the disk rotation to halt.

In an optional step 110, manager 54 checks parameters of the suspect disk, to ensure that the transferred data may be rewritten to the disk. If the check determines that the disk is not in a condition to receive the transferred data, process 100 concludes. Such a condition may be that the disk has more than a preset fraction of bad sectors and/or has a mechanical problem. If the check determines that the disk is in a condition to receive the transferred data, process 100 continues at step 112.

In second data transfer step 112, if in step 106 manager 54 has maintained record 33, the manager refers to the record and copies the data transferred in step 106 back to the suspect disk. Alternatively, if a record is not maintained in step 106, the manager transfers other data from disks 12 to the suspect disk, typically to maintain load balancing. Typically the second data copying is performed in batches, in a generally similar manner to that described in step 106, so that the copying process is atomic and includes updating mappings 28 and/or location tables 21 to reflect the relocating of the data to the suspect disk. When all the data has been copied back to the suspect disk, and the mappings and location tables have been updated, manager 54 erases the data copies on the other disks 12, which have now become surplus. If record 33 has been used, manager 54 also erases the record. Process 100 then concludes.

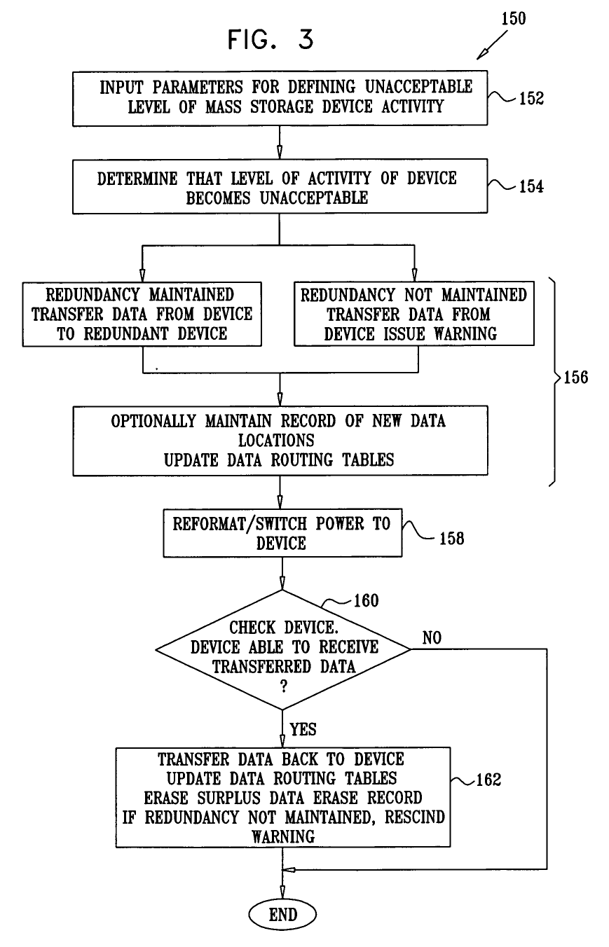

FIG. 3 is a flowchart of an alternative process 150 showing steps taken by manager 54 in the event that the activity of one of disks 12, herein termed the suspect disk, becomes unacceptable, according to an embodiment of the present invention. Process 150 assumes that the data stored on the suspect disk has been stored redundantly on at least one of the other disks 12, and that the redundant data may be used while the process is being implemented. U.S. Patent Application 2005/0015554 describes processes that may advantageously be used, mutatis mutandis, in the data transfer steps of process 150 described below, to maintain redundancy.

Steps 152 and 154 are respectively substantially similar to steps 102 and 104, described above.

In a first data transfer step 156, manager 54 begins copying data from the suspect disk to one or more of the other disks 12. The data is typically copied in batches so as to maintain the redundancy. In other words, if a batch of data was originally redundantly stored on a first disk 12 and on a second disk 12, and first disk 12 becomes the suspect disk, manager 54 ensures that a new copy of the batch is not written to the second disk 12. The data is also typically copied so as to maintain load balancing.

Alternatively, in step 156 the redundancy may not be maintained, and in the above example, manager 54 may write the new batch copy to any of disks 12 other than the first disk. In this case, a warning is typically issued to an operator of system 10 indicating the possibility of non-redundant data.

As each batch of data is copied, manager 54 updates mappings 28 and/or location tables 21, as necessary, to handle incoming IO requests. If redundancy has been maintained, IO requests for copied data are directed to one of the redundant locations of the data. If redundancy has not been maintained IO requests are directed to the redundant location of the data being copied.

Other actions performed by manager 54 in step 156 are generally similar to those described above for step 106. Thus, copying of a batch typically includes confirmation by manager 54 that the copied data in the new location is identical to the original batch on the suspect disk. The process of copying a specific batch, and updating mappings 28 and/or location tables 21 for the batch, is typically implemented by manager 54 as an atomic process. Manager 54 may also maintain record 33 of the data that has been transferred, for use in a second data transfer step 162, described below.

At completion of step 156, manager 54 performs a step 158, substantially similar to step 108 described above. Thus, in step 156 manager reformats the suspect disk, and/or powers the suspect disk down, then returns power to the disk.

An optional step 160 is substantially similar to step 110 described above. Thus, if in step 160 manager 54 determines that the disk is not in a condition to receive the erased data, process 150 concludes. If the manager determines that the disk is in a condition to receive the erased data, process 150 continues at step 162.

Second data transfer step 162 is generally similar to step 112 described above. In the event that in step 156 redundancy is not maintained and a warning is issued, at the conclusion of step 162 the warning is rescinded. When step 162 finishes, process 150 concludes.

It will be appreciated that while the description above has been directed to transfer of data from and to non-volatile mass storage devices such as disks, the scope of the present invention also includes volatile mass storage devices, such as may be used for caches, in the event that a level of activity of these devices becomes unacceptable. It will also be appreciated that while the description above has been directed to a data storage system having separate interfaces, caches, and mass storage devices, the scope of the present invention includes data storage systems where at least some of these elements are combined as one or more units.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

We claim:

1. A method for operating a data storage system adapted to respond to input/output (IO) data requests from one or more hosts, the system including a first and one or more second mass storage devices, each of the devices having respective data stored therein, the method comprising:
defining an unacceptable level of activity; and
performing the following steps automatically, without intervention by a human operator:
detecting the unacceptable level of activity on the first mass storage device,
in response to detecting the unacceptable level of activity, transferring the data stored in the first mass storage device to the one or more second mass storage devices, while responding to the IO data requests,
reformatting the first mass storage device, and
after reformatting the first mass storage device, transferring the data stored in the one or more second mass storage devices to the first mass storage device, while responding to the IO data requests.

2. The method according to claim 1, wherein defining the unacceptable level of activity comprises receiving one or more parameters related to the IO data requests from the human operator, and the human operator setting the unacceptable level of activity in terms of the one or more parameters.

3. The method according to claim 1, wherein at least some of the first and the one or more second mass storage devices comprise volatile mass storage devices.

4. The method according to claim 1, wherein at least some of the first and the one or more second mass storage devices comprise non-volatile mass storage devices.

5. The method according to claim 1, wherein transferring the data to the one or more second mass storage devices comprises copying the data to the one or more second mass storage devices and maintaining a record of locations of the data on the one or more second mass storage devices.

6. The method according to claim 5, wherein transferring the data stored in the one or more second mass storage devices to the first mass storage device comprises using the record to locate the data.

7. The method according to claim 6, and comprising erasing the record and the data copied to the one or more second mass storage devices.

8. The method according to claim 1, wherein reformatting the first mass storage device comprises checking, after the reformatting, that the device is in a condition to receive the data stored in the one or more mass second mass storage devices.

9. The method according to claim 1, and comprising, in response to transferring the data stored in the first mass storage device, updating routing tables for the IO data requests.

10. The method according to claim 1, wherein the first and the one or more second mass storage devices store the respective data with redundancy, and wherein updating the routing tables comprises updating the tables in response to the redundancy.

11. The method according to claim 1, wherein the one or more second mass storage devices comprise two or more second mass storage devices, and wherein the first and the two or more second mass storage devices store the respective data with redundancy, and wherein transferring the data stored to the two or more second mass storage devices comprises copying the data to the two or more second mass storage devices so as to maintain the redundancy.

12. Apparatus for operating a data storage system adapted to respond to input/output (IO) data requests from one or more hosts, the system including a first and one or more second mass storage devices, each of the devices having respective data stored therein, the apparatus comprising:
a system manager which is adapted to:
receive a defined unacceptable level of activity, and
perform the following steps automatically, without intervention by a human operator:
detect the unacceptable level of activity on the first mass storage device,
in response to detecting the unacceptable level of activity, transfer the data stored in the first mass storage device to the one or more second mass storage devices, while responding to the IO data requests,
reformat the first mass storage device, and
after reformatting the first mass storage device, transfer the data stored in the one or more second mass storage devices to the first mass storage device, while responding to the IO data requests.

13. The apparatus according to claim 12, wherein the defined unacceptable level of activity is provided to the system manager by the human operator, and wherein the human operator sets the unacceptable level of activity in terms of one or more parameters related to the IO data requests.

14. The apparatus according to claim 12, wherein at least some of the first and the one or more second mass storage devices comprise volatile mass storage devices.

15. The apparatus according to claim 12, wherein at least some of the first and the one or more second mass storage devices comprise non-volatile mass storage devices.

16. The apparatus according to claim 12, wherein transferring the data to the one or more second mass storage devices comprises copying the data to the one or more second mass storage devices and maintaining a record of locations of the data on the one or more second mass storage devices.

17. The apparatus according to claim 16, wherein transferring the data stored in the one or more second mass storage devices to the first mass storage device comprises using the record to locate the data.

18. The apparatus according to claim 17, and comprising erasing the record and the data copied to the one or more second mass storage devices.

19. The apparatus according to claim 12, wherein reformatting the first mass storage device comprises checking, after the reformatting, that the device is in a condition to receive the data stored in the one or more mass second mass storage devices.

20. The apparatus according to claim 12, and comprising, in response to transferring the data stored in the first mass storage device, updating routing tables for the IO data requests.

21. The apparatus according to claim 12, wherein the first and the one or more second mass storage devices store the respective data with redundancy, and wherein updating the routing tables comprises updating the tables in response to the redundancy.

22. The apparatus according to claim 12, wherein the one or more second mass storage devices comprise two or more second mass storage devices, and wherein the first and the two or more second mass storage devices store the respective data with redundancy, and wherein transferring the data stored to the two or more second mass storage devices comprises copying the data to the two or more second mass storage devices so as to maintain the redundancy.

23. A method for operating a data storage system adapted to respond to input/output (IO) data requests from one or more hosts, the system including a first and one or more second mass storage devices, each of the devices having respective data stored therein, the method comprising:
defining an unacceptable level of activity; and
performing the following steps automatically, without intervention by a human operator:
detecting the unacceptable level of activity on the first mass storage device,
in response to detecting the unacceptable level of activity, transferring the data stored in the first mass storage device to the one or more second mass storage devices, while responding to the IO data requests,
powering down then powering up the first mass storage device, and
after powering up the first mass storage device, transferring the data stored in the one or more second mass storage devices to the first mass storage device, while responding to the IO data requests.

24. The method according to claim 23, wherein transferring the data stored in the one or more second mass storage devices to the first mass storage device comprises first reformatting the first mass storage device.

25. Apparatus for operating a data storage system adapted to respond to input/output (IO) data requests from one or more hosts, the system including a first and one or more second mass storage devices, each of the devices having respective data stored therein, the apparatus comprising:
a system manager which is adapted to:
receive a defined unacceptable level of activity, and
perform the following steps automatically, without intervention by a human operator:
detect the unacceptable level of activity on the first mass storage device,
in response to detecting the unacceptable level of activity, transfer the data stored in the first mass storage device to the one or more second mass storage devices, while responding to the IO data requests,
power down then power up the first mass storage device, and
after powering up the first mass storage device, transfer the data stored in the one or more second mass storage devices to the first mass storage device, while responding to the IO data requests.

26. The apparatus according to claim 25, wherein transferring the data stored in the one or more second mass storage devices to the first mass storage device comprises first reformatting the first mass storage device.
